(19) United States
(12) Patent Application Publication
(10) Pub. No.: US 2016/0125443 A1
(43) Pub. Date: May 5, 2016

(54) Method of Implementing an Associate Referral Compensation System with a 1.5-ary hierarchical rooted tree

(71) Applicant: Raymond C Merritt, JR., Berwyn Heights, MD (US)

(72) Inventor: Raymond C Merritt, JR., Berwyn Heights, MD (US)

(21) Appl. No.: 14/923,205

(22) Filed: Oct. 26, 2015

Related U.S. Application Data
(60) Provisional application No. 62/072,127, filed on Oct. 29, 2014.

(51) Int. Cl. G06Q 30/02; G06Q 50/00; G06Q 10/10

(52) U.S. Cl. CPC G06Q 30/0214; G06Q 10/105; G06Q 50/01

(57) ABSTRACT

In a 1.5-ary hierarchical rooted tree compensation-based referral marketing system, each associate in the tree has one whole associate spot and one half associate spot in a subordinate tier of the tree. New associate referrals are places into the upmost, leftmost open spot in the tree. Referrals are either placed into a whole spot downline of the referring associate, or into two half spots downline of the referring associate, depending on whether the upmost, leftmost unoccupied associate spot is a whole spot or a half spot. Referrals by an associate in two half spots alternate downline of the two half spots occupied by the referrer. Associates in whole spots earn each commissions earned by each downline associate, and associates in two half spots earn half commission for each associate downline of both half spots.

The current application claims a priority to the U.S. Provisional Patent application Ser. No. 62/072,127 filed on Oct. 29, 2014.

### FIELD OF THE INVENTION

The present invention relates generally to multilevel marketing. More particularly, the present invention relates to compensation-based referral system with a forced 1.5-ary matrix of associates.

### BACKGROUND OF THE INVENTION

Multi-level marketing or network marketing is a class of business model in which distributors, receive compensation for their own sales, and for the sales of distributor whom they refer. Examples of successful multi-level marketing companies have become household names including Avon, Electrolux and Tupperware. Forced matrices are often used to determine the compensation of distributors within these systems. One of the main advantages of the forced matrix over unilevel and binary plans and others is that once a front line is filled, focus is shifted to down line sales and referrals. Two popular forced matrices are the 2× and 3× forced matrices. In the 2× forced matrix, each distributor has two whole spots on his or her front line. When a first distributor refers second and third distributors, the second and third distributors will occupy the two spots on the first distributor's front line. Any more distributors who are referred by the first, second, or third distributors will be placed downstream from either the second or third distributor. Therefore, each distributor has his or her lineage which is in competition with the lineages of all other distributors on the same level of the forced matrix. There is no incentive for the second or third distributors to work together in this kind of a system. The 3× forced matrix work in the same way, except that each distributor has three whole spots on his or her front line. In both the 2× and 3× forced matrix compensation systems, lineages are formed as separate, competing teams, and there is still no incentive for distributors to work as a team with other distributors on the same level.

The system of the present invention includes a new kind of forced matrix in which new referrals may be “split” into two different lineages. It is the objective of the present invention to introduce a system based on a narrower forced matrix which causes more spillover to be generated, and in turn stimulates a greater amount of teamwork and collaboration between distributors in the system.

### BRIEF DESCRIPTION OF THE DRAWINGS

FIG. 1 is a diagram of an unpopulated 1.5-ary hierarchical rooted tree with a top spot and three subordinate tiers.

FIG. 2 is a stepwise flow diagram of the general process of the present invention.

FIG. 3 is a stepwise flow diagram describing steps for initiating the hierarchical rooted tree by the primary associate.

FIG. 4 is a stepwise flow diagram describing steps for searching through the hierarchical associate tree for unoccupied associate spots and assigning new associates to the unoccupied spots.

FIG. 5 is a stepwise flow diagram describing steps for assigning new associates downline of a referring associate in two half spots.

FIG. 6 is a stepwise flow diagram describing steps for assigning commissions to associates in whole spots.

FIG. 7 is a stepwise flow diagram describing steps for assigning commissions to associate in two half spots.

FIG. 8 is a diagram of a 1.5-ary hierarchical rooted tree populated according to the direct referral tree in FIG. 9.

FIG. 9 is a diagram showing direct referrals corresponding with the populated 1.5-ary hierarchical rooted tree in FIG. 8.

FIG. 10 is another visualization of the 1.5-ary hierarchical rooted tree wherein relative positions of associates within the 1.5-ary hierarchical rooted tree are demonstrated by location, and referrals are demonstrated by lines between associates.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

The present invention is a marketing compensation system utilized by a multi-level marketing company based on a 1.5× grid, also known as a 1.5-ary forced matrix of associates in which compensation based on referrals is distributed in a manner that incentivizes collaboration between associates in the system. Associates may also be referred to as distributors or participants.

Each distributor is an independent agent who markets and sells items provided by the multi-level marketing company. Each distributor is referred by another distributor, and may refer additional distributors or customers. The profits from a sale made by a distributor are divided between the selling distributor, the distributor who referred the selling distributor, the distributor who referred the referring distributor, and so on back to the primary associate. For the purposes of the present invention, customers are a subcategory of distributors who do not refer other distributors, and do not sell items from the multi-level marketing company. Customers, however, may be placed into the 1.5× grid. Thus, the term associate encompasses both distributors who actively participate in sales and customers who do not. The primary associate, as a point of reference, may be the person or business entity which directly signs up with a multi-level or network marketing or marketing company, and is not referred by any other participants in the system. In a preferred embodiment, the multi-level marketing company is an online retailer of print-on-demand apparel and other merchandise, though any relevant type of retailer or other business may be applied.

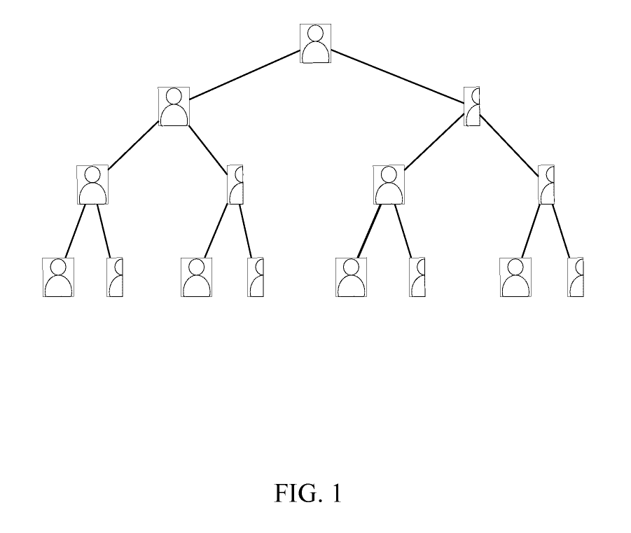

The following is a general overview of the present invention. The commission-based compensations are the quantities of money that each distributor in the system receives when one distributor sells an item. The proportion of the compensation per sale received by a selling distributor and the up line distributors in the same genealogy is determined by the 1.5× grid. The 1.5× grid, shown in FIG. 1, is a forced matrix which further comprises a top spot, and a plurality of levels. The top spot is occupied by the primary associate and is above the plurality of levels. Levels above particular levels are described as being “up line,” and levels below particular levels are described as being “down line.” Each level further comprises a plurality of half spots, and a plurality of whole spots. Each whole spot is directly up line of one whole spot and one half spot, and each half spot is also directly up line of one whole spot and one half spot. The first level further comprises one whole spot and one half spot, the second level comprises two whole spots, and two half spots, and each subsequent level comprises twice the number of whole spots and half spots as the level directly up line. Each distributor placed into the 1.5× grid may occupy either one whole spot or two half spots. When distributors are referred by other distributors, they are placed down line of the distributor who referred them, going from left to right and from top to bottom in sequence. The distributors who are on the next level down line of a particular distributor are referred to collectively as that particular distributor's first line. Distributors who are placed in one whole spot have one and one half distributors in their front line, and distributors who are placed in two half spots have three distributors in their front line. When distributors who are placed into two half spots refer other distributors, the position into which the referred distributor is placed alternates between the positions down line of the first and second half spots of the referring distributor.

All of the distributors who are down line of a particular distributor make up that distributor's lineage. Any distributor who is placed into two half spots will be split between two separate lineages. In the preferred embodiment of the present invention, the placement of new referrals into the 1.5× grid and the calculation of the commission-based compensations for each distributor are carried out by a computer. Despite the difference in the number of front-line positions between distributors who are placed in one whole spots or in two half spots, the potential compensation remains the same. The commission based compensations on each of the down line lineages of a distributor who are split into two half spots are fifty percent of the commission based compensations on the down line lineage of a distributor who is not split into two half spots. Thus, a distributor who occupies a whole spot within the matrix will collect one hundred percent of the potential commission-based compensations of his or her down line lineage, and a distributor who occupies two half spots will collect fifty percent of the potential commission-based compensations of each of his or her down line lineages.

The specific proportion of the profit from a sale that is received by each distributor in the lineage may be determined by a fixed or a variable commission rate. In a preferred embodiment, distributors will make commissions biweekly on all active members in the odd levels of their grid, and the commission rate would be fixed at four percent. Because the commissions from half of all new referrals are split between the lineages of distributors on the same level of the grid, those distributors have an incentive to work together to develop their common lineage. Once a distributor's front line is filled, referrals made by that distributor may be placed far down line of the referring distributor. Therefore, additional compensation or other rewards may be used to incentivize that distributor to manage the distributors whom he or she has referred. Distributors are responsible for managing and working with the distributors whom they have directly referred, no matter where those referred distributors are placed in the grid. In a preferred embodiment, distributors will receive compensation which matches the total combined compensation of all distributors whom that distributor has referred. In this embodiment, distributors will receive commission-based compensations biweekly on all active members on the odd levels, and receives the matching compensation from the even levels of the 1.5× grid.

A hierarchal associate tree is utilized in the present invention, wherein the hierarchical associate tree is a 1.5-ary rooted tree. The hierarchical associate tree comprises a plurality of associate spots arranged into a plurality of tiers.

In graph theory, a tree is a graph of nodes in which any two nodes are connected by exactly one path. A rooted tree is a tree where a single node or is designated the root, in which case additional connected nodes extend away from the root. A k-ary tree is a rooted tree for which each node has at most k children. For example, in a binary tree, or 2-ary tree, each node has at most two children, typically referred to as the “left child” and “right child.” Similarly, 3-ary trees are called ternary trees. The present invention uses a 1.5-ary tree, which is similar to a binary tree in that each node has two child nodes, but with the exception that one of the child nodes is a half node. Thus, in the application of the present invention, new associates to be placed into the hierarchical associate tree may either be placed into a whole spot or two half spots in the hierarchical associate tree. The nodes of the hierarchical associate tree of the present invention are known as associate spots to which referred associates are assigned.

Given two arbitrary tiers, a lower tier is subordinate to the higher tier, and the higher tier is superior to the lower tier. If the higher and lower tiers in this example are adjacent to each other in the hierarchical associate tree, they may be called immediately subordinate or superior. The word subsequent is also used herein to describe a tier immediately subordinate to another tier. Thus, in the preferred embodiment of the present invention, the hierarchical associate tree branches downwards from the primary associate, who is at the top of the hierarchical associate tree. However, the present invention should not be limited to the top down direction and will perform the same way if the hierarchical associate tree is inverted, with the hierarchical associate tree branching upward and with the primary associate at the bottom of the hierarchical associate tree. The same applies to any other direction in a visual depiction of the hierarchical associate tree—the important aspects of the branching structure of the present invention are that it is a 1.5-ary rooted hierarchical tree, with each node having a subsequent whole spot and half spot. In the hierarchical associate tree, each tier comprises at least one associate spot.

An associate spot is deemed occupied if an associate is currently assigned to the associate spot, and an associate spot is deemed unoccupied if an associate is not currently assigned to the associate spot.

Any arbitrary associate spot from the plurality of associate spots on an arbitrary tier from the plurality of tiers is associated with a whole associate spot and a half associate spot from the plurality of associate spots on a subsequent tier, wherein the subsequent tier is immediately subordinate tier to the arbitrary tier. The whole associate spot and the half associate spot of the subsequent tier are considered to be downline of the arbitrary associate spot. Any subsequent associate spots on subordinate tiers associated with the whole associate spot and the half associate spot of the arbitrary associate spot are also considered to be downline of the arbitrary associate spot.

It is important to note the distinction between subordinate and downline. Downline refers to a “lineage” of associate spots which branch downward from a specific associate spot. Subordinate simply means on a lower tier. Thus, any associate spot downline of a specific associate spot is always subordinate to the specific associate spot, but an associate spot subordinate to a specific associate spot is not always downline of the specific associate spot. For example, peer associate spots on the same tier have separate lineages. Every associate spot in the two lineages is subordinate to both of the peer associate spots, but only spots in the lineages of the peer associate spots are downline of their respective peer associate spot.

In the preferred embodiment of the present invention, the whole associate spot is considered to be the left child of the arbitrary associate spot, and the half associate spot is considered to be the right child of the arbitrary associate spot. Thus, for any tier, whole associate spots and half associate spots alternate across the tier, beginning with a whole associate spot. In other embodiments, the whole associate spot may be the right child of the arbitrary associate spot, with the half associate spot being the left child of the arbitrary associate spot. In this case, the scheme for assigning new associates in a given tier is reversed—right to left as opposed to left to right.

The plurality of associate spots is arranged into a plurality of tiers in the hierarchical associate tree, comprising a primary tier and a plurality of subordinate tiers. The primary tier is the root of the hierarchical associate tree, comprising a single primary associate spot with a primary associate assigned to the primary associate spot. The plurality of subordinate tiers is sequentially subordinate to the primary tier in the hierarchical associate tree. Due to the structure of the hierarchical associate tree, each subsequent tier has twice as many associate spots as the tier above it. The primary tier comprises one associate spot, the second tier comprises two associate spots, the third tier comprises four associate spots, the fourth tier comprises eight associate spots, and so on.

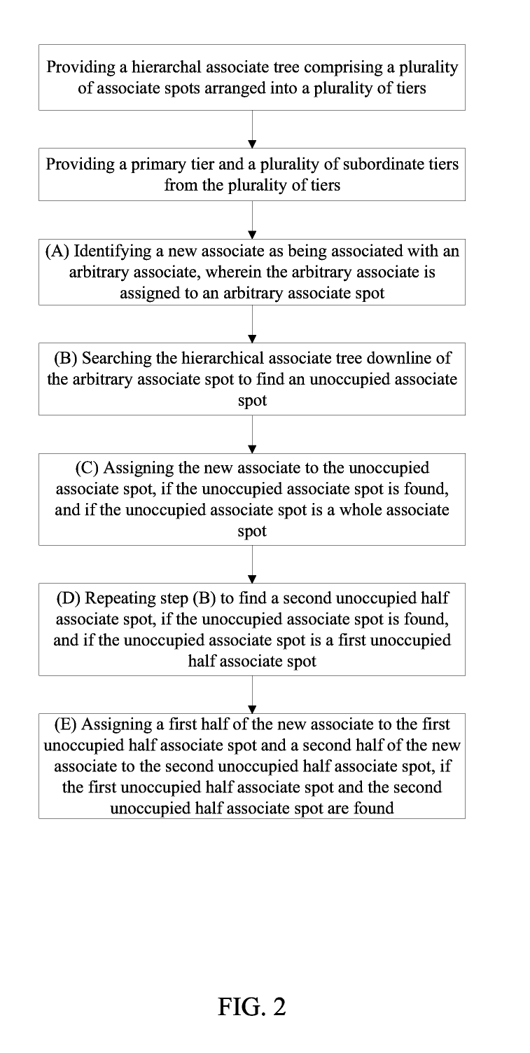

Referring to FIG. 2, in the general process of the present invention, a new associate is identified as being associated with an arbitrary associate that is assigned to an arbitrary associate spot in the hierarchical associate tree (A). An unoccupied spot downline of the arbitrary associate spot must then be located into which the new associate is to be placed. The hierarchical associate tree is searched downline of the arbitrary associate tree to find an unoccupied associate spot (B). The hierarchical associate tree is searched sequentially from top to bottom and left to right for the next available unoccupied associate spot, assuming the hierarchical associate tree is depicted visually with the primary associate at the top with subsequent tiers below the primary tier, and with whole associate spots being the left child and half associate spots being the right child of parent nodes in the hierarchical associate tree.

If and when the unoccupied associate spot is found, then the new associate is assigned to the unoccupied associate spot, if the unoccupied associate spot is a whole associate spot (C). If the unoccupied associate spot is found, and the unoccupied associate spot is a first unoccupied half associate spot, then a second unoccupied half associate spot must also be found. In this case, step (B) is repeated to find the second unoccupied half associate spot. If and when the first unoccupied half associate spot and the second unoccupied half associate spot are found, a first half of the new associate is assigned to the first unoccupied half associate spot, and a second half of the new associate is assigned to the second unoccupied half associate spot. Put simply, new associates referred by a referring associate are assigned to the topmost, leftmost unoccupied associate spot in the hierarchical associate tree downline of the referring associate.

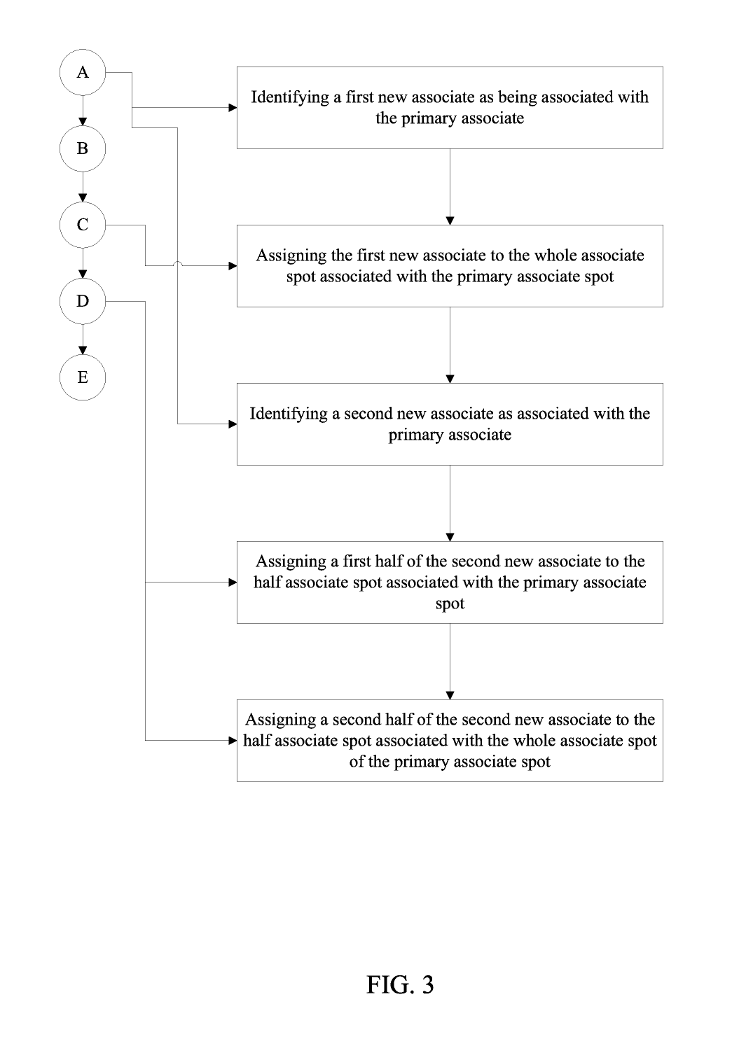

Referring to FIG. 3, to initiate the process, the primary associate is assigned to the primary associate spot, which is the sole associate spot on the primary tier. At this point, no associate spots other than the primary associate spot are occupied. The primary associate then refers a first new associate, and the first new associate is identified as being associated with the primary associate in the hierarchical associate tree. The main process described above is performed, but since all associate spots in the hierarchical associate tree save the primary associate spot are unoccupied, placing the first new associate is simple—the first new associate is assigned to the whole associate spot associated with the primary associate spot, wherein the whole associate spot in question is on the second tier, which is immediately subordinate to the primary tier. The second tier only comprises the whole associate spot and the half associate spot associated with the primary associate spot.

For the sake of example, the primary associate may then refer a second new associate, though this is not specifically required in the present invention—the primary associate may simply refer the first new associate and not refer any additional new associates. Since the whole associate spot on the second tier is already occupied, the next upmost, leftmost unoccupied associate spot is the half spot on the second tier. Thus, a first half of the second new associate is assigned to the half associate spot associated with the primary associate spot, and assuming the first new associate has not already referred at least two new associates, a second half of the second new associate is assigned to the half associate spot associated with the whole associate spot of the primary associate spot. This results in the second new associate being split between the half associate spot on the second tier, and the leftmost half associate spot on the third tier.

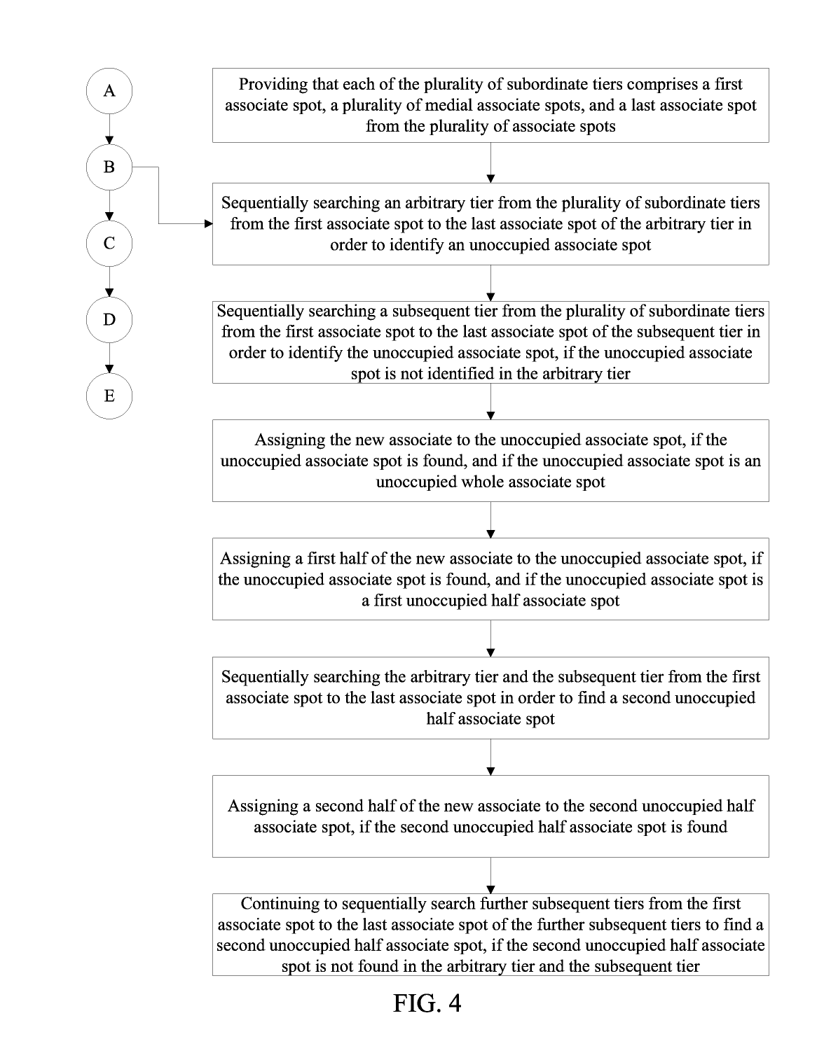

As shown in FIG. 4, the generalized process for searching the hierarchical associate tree downline of an arbitrary associate spot to find an unoccupied associate spot is as follows. Each of the plurality of subordinate tiers comprises a first associate spot, a plurality of medial associate spots, and a last associate spot from the plurality of associate spots. Assuming that whole spots are the left child of their parents and that half spots are the right child of their parents, the first associate spot, the plurality of medial associate spots, and the last associate spot are arranged sequentially left to right across each of the plurality of subordinate tiers in a visual depiction of the hierarchal associate tree. The plurality of subordinate tiers, in this case, should be understood to be subordinate to the arbitrary associate spot, and the first associate spot, the plurality of medial associate spots, and the last associate spot are also understood to be downline of the arbitrary associate spot.

Starting with the tier immediately subordinate to the arbitrary associate spot and proceeding downwards, an arbitrary tier from the plurality of subordinate tiers is sequentially searched from the first associate spot to the last associate spot of the arbitrary tier in order to identify an unoccupied associate spot. In other words, the arbitrary tier is searched left to right to find the unoccupied associate spot.

If the unoccupied associate spot is not identified in the arbitrary tier, the search continues, and a subsequent tier from the plurality of subordinate tiers is searched from the first associate spot to the last associate spot of the subsequent tier (left to right) in order to identify the unoccupied associate spot. If the unoccupied associate spot is not identified in the subsequent tier, the process repeats in order to continue the search, with the subsequent tier taking the place of the arbitrary tier.

If and when the unoccupied associate spot is found, and if the unoccupied associate spot is a whole associate spot, the new associate is assigned to the unoccupied associate spot.

If the unoccupied associate spot is a first unoccupied half associate spot, a first half of the new associate is assigned to the first unoccupied half associate spot, and the process repeats to find a second unoccupied half associate spot. The tier the first unoccupied half associate spot was found on is continued to be searched, if there are remaining unsearched associate spots on the tier of the first unoccupied half associate spot. To this end, the arbitrary tier and the subsequent tier are searched from the first associate spot to the last associate spot in order to find a second unoccupied half associate spot. In this case, the arbitrary tier should be understood to be the tier upon which the first half associate spot was found. If the second unoccupied half associate spot is found, a second half of the new associate is assigned to the second unoccupied half associate spot. If the second unoccupied half associate spot is not found in the arbitrary tier and the subsequent tier, the search continues and further subsequent tiers are sequentially searched from the first associate spot to the last associate spot of each of the further subsequent tiers in order to find the second unoccupied half associate spot.

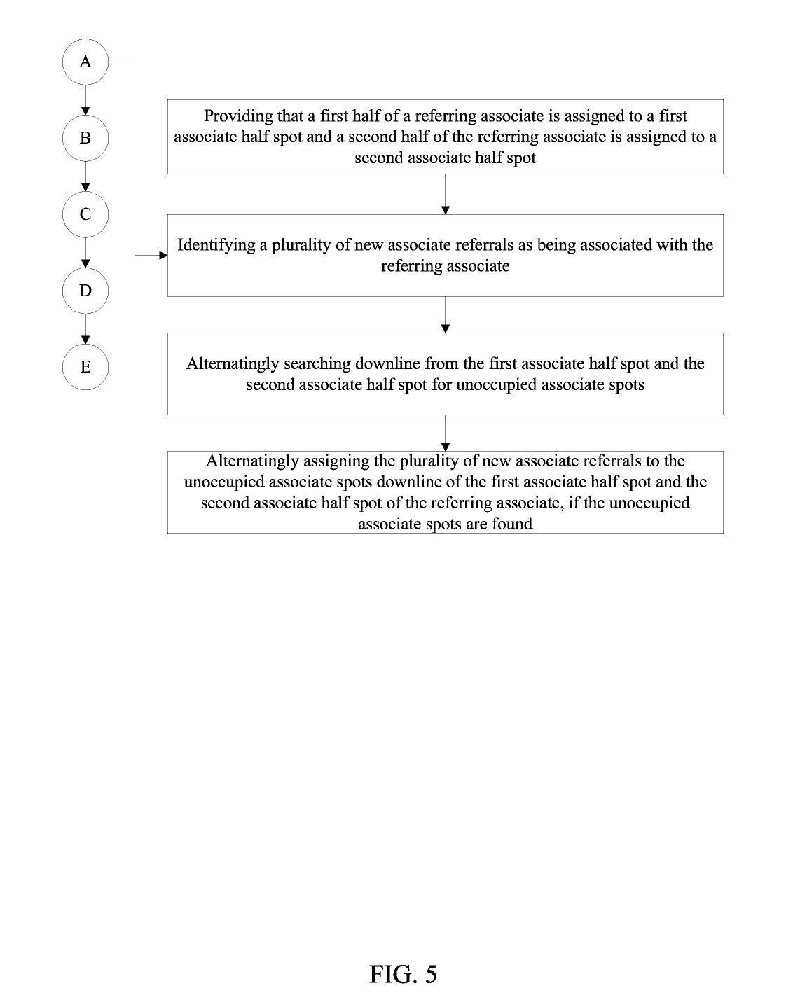

Referring to FIG. 5, when an associate is assigned to two half associate spots, any referrals by that associate are alternatingly assigned downline of the two half spots the associate is assigned to. In this situation, a first half of a referring associate is assigned to a first associate half spot and a second half of the referring associate is assigned to a second associate half spot. A plurality of new associate referrals are identified as being associated with the referring associate. Subsequently, the hierarchical associate tree is alternatingly searched downline from the first associate half spot and the second associate half spot for unoccupied associate spots in the manner previously described. Accordingly, the plurality of new associate referrals are alternatingly assigned to the unoccupied associate spots found downline of the first associate half spot and the second associate half spot to which the referring associate is assigned, if the unoccupied associate spots are found. A first referral by the referring associate is assigned downline of the first associate half spot of the referring associate, a second referral by the referring associate is assigned downline of the second associate half spot of the referring associate, a third referral by the referring associate is assigned downline of the first associate half spot of the referring associate, and so on.

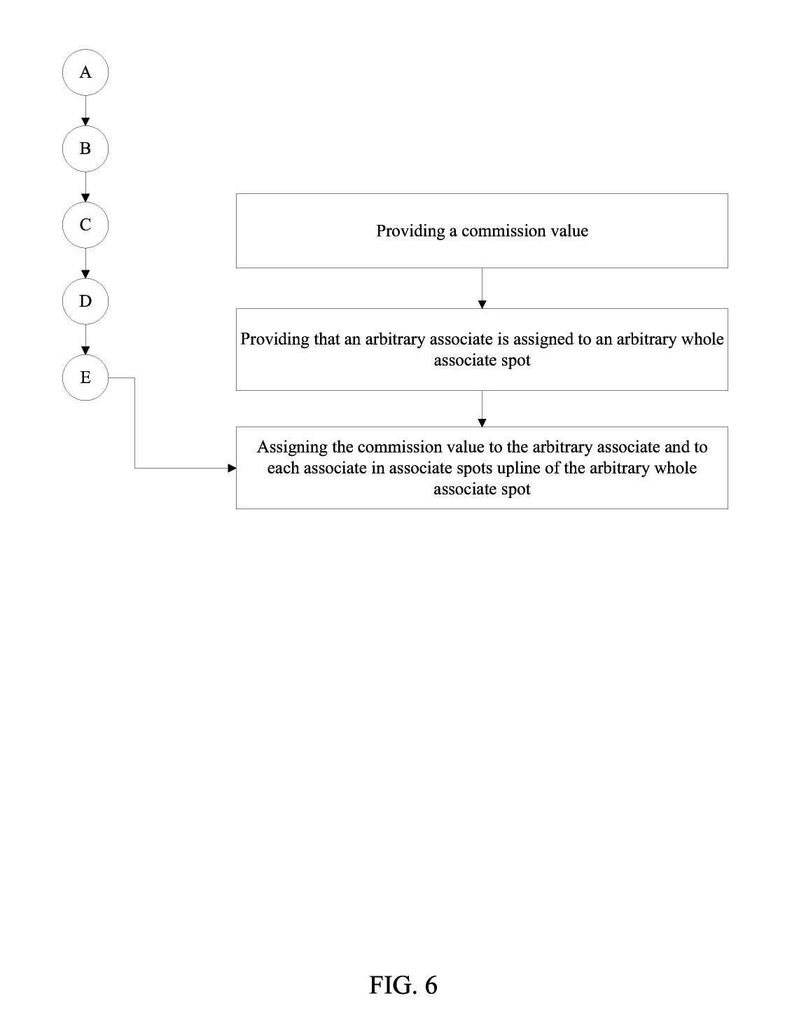

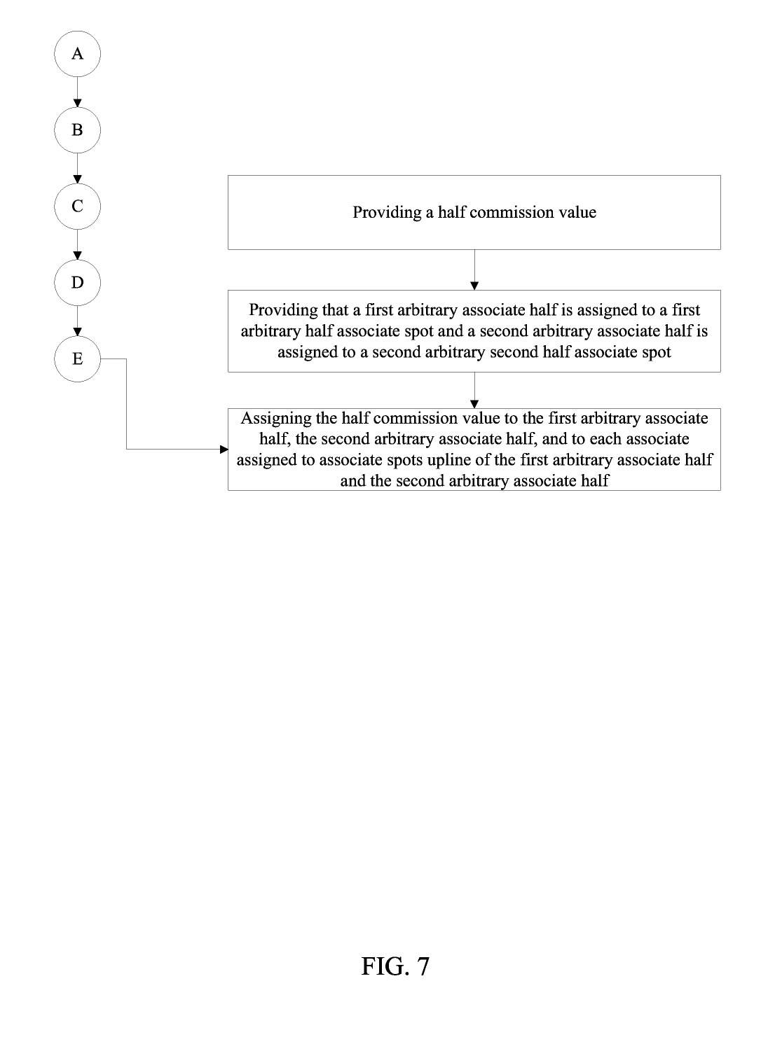

The purpose of the 1.5-ary structure of the hierarchical associate tree is primarily to facilitate cooperation between associates on different tiers in a more efficient manner than with a binary tree. Any sale made by an associate is associated with a commission value provided to the associate making the sale. Commissions on sales made by associates are distributed to each member upline of the associate making the sale and getting the commission. In reference to FIG. 6, providing that an arbitrary associate is assigned to an arbitrary whole associate spot, the commission value is assigned to the arbitrary associate and to each associate in associate spots upline of the arbitrary whole associate spot. In reference to FIG. 7, in the case that a first half of an arbitrary associate of an arbitrary associate is assigned to a first arbitrary half associate spot and a second arbitrary associate half of the arbitrary associate is assigned to a second arbitrary half associate spot, a half commission value is assigned to the first arbitrary associate half, the second arbitrary associate half, and to each associate assigned to associate spots upline of the first arbitrary associate half and the second arbitrary associate half.

The following example is the simplest illustration of the placement of distributors by a computer into the 1.5× grid. When a primary associate refers a first distributor and a second distributor, the first distributor is placed in the first whole spot on the primary associate's front line, half of the second distributor is placed in the remaining half spot of the primary associate's front line, and half of the second distributor is placed in the half spot of the first distributor's front line. Therefore when the second distributor sells an item, both the primary associate and the first distributor receive compensation. Placing a referred distributor into two half spots within two separate lineages encourages teamwork between two distributors on the same level of the 1.5× grid.

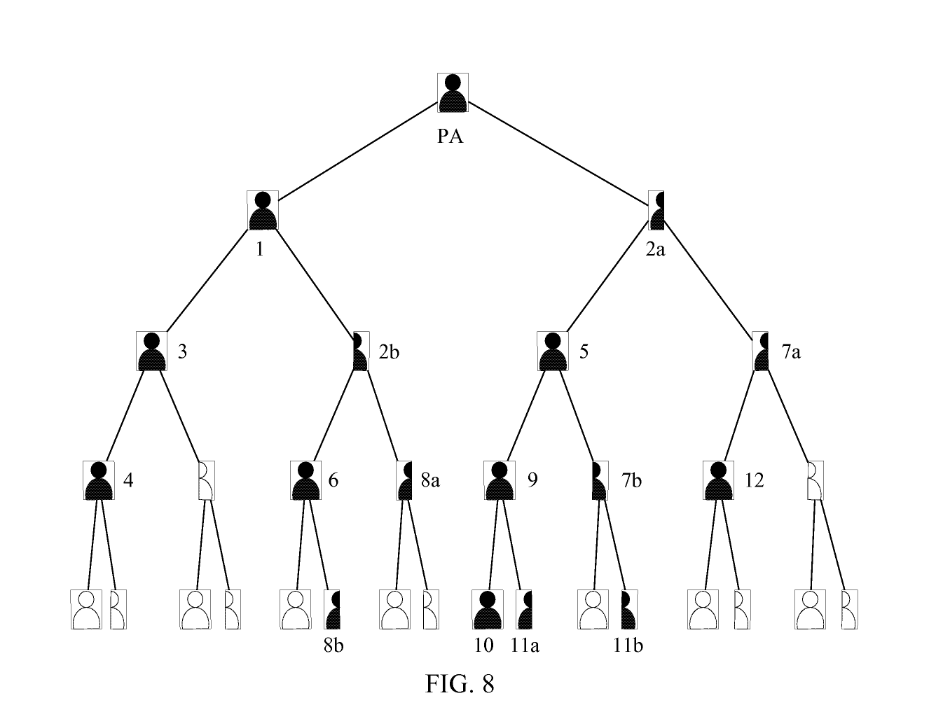

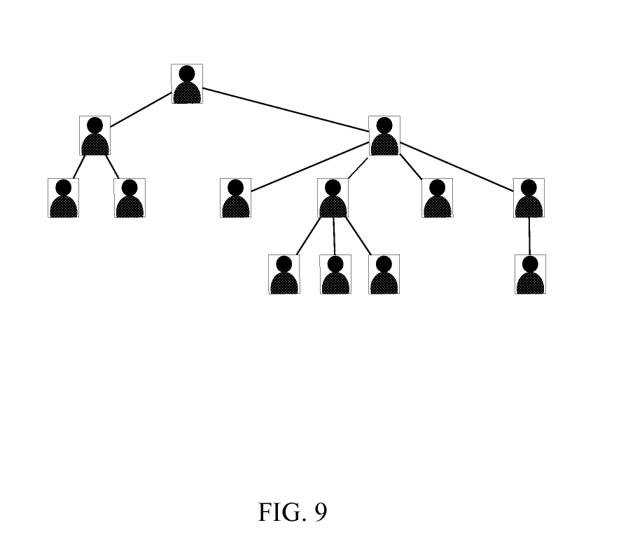

The following example is a more extensive illustration of the placement of distributors by a computer into the 1.5× grid and corresponds with FIG. 8 and FIG. 9.

First, a primary associate registers with the multi-level marketing company. Then the primary associate refers distributor 1, and distributor 2. Distributor 1 is placed on the leftmost whole spot of the primary associate's front line. Distributor 2 is split into distributor 2a and distributor 2b, each representing half of distributor 2. Distributor 2a is placed in the remaining half spot of the front line of the primary associate, and distributor 2b is placed into the half spot on the front line of distributor 1. Distributor 1 then refers distributor 3 and distributor 4. Distributor 3 is placed into the remaining whole spot of the front line of distributor 1, and distributor 4 is placed into the upmost, leftmost open position down line of distributor 1, which is the whole spot on the front line of distributor 3. Distributor 2 then refers distributor 5, distributor 6, distributor 7, and distributor 8. Distributor five is placed into the upmost open position on the front line of distributor 2, which is the whole spot on the front line of distributor 2a. Distributor six is placed into the whole spot on the front line of distributor 2b. Distributor 7 is then placed into the upmost and leftmost open positions down line of distributor 2. Distributor 7 is split into distributor 7a and distributor 7b. Distributor 7a is placed in the remaining half spot on the front line of distributor 2a, and distributor 7b is placed in the remaining half spot on the front line of distributor 5. Distributor 8 is then placed into the upmost and leftmost open positions down line of distributor two, and is therefore split into distributor 8a and distributor 8b. Distributor 8a is placed into the remaining half spot on the front line of distributor 2b. Distributor 8b is placed in the upmost, leftmost open position down line of distributor 2, which is the half spot on the front line of distributor 6. Distributor 5 then refers distributor 9, distributor 10, and distributor 11. Distributor 9 is placed in the upmost leftmost open position down line of distributor 5, which is the whole spot on the front line of distributor 5. Distributor 5's front line is now completely full, and additional referrals made by distributor 5 must be placed in the front lines of distributors down line of distributor 5. Distributor 10 is placed in the whole spot below distributor 9. Distributor 11 is split into distributor 11a and distributor 11b, each representing half of distributor 11. Distributor 11a is placed in the upmost, leftmost open half spot down line of distributor 5 and is therefore placed into the half spot on the front line of distributor 9. Distributor 11b is placed in the upmost, leftmost open half spot down line of distributor 5 and is therefore placed in the half spot on the front line of distributor 7b. Distributor 7 then refers distributor 12. Distributor 12 is placed in the upmost, leftmost open position down line of distributor 7, and is therefore placed in the whole spot on the front line of distributor 7a. This pattern may be repeated for as many referrals made in the system of the present invention.

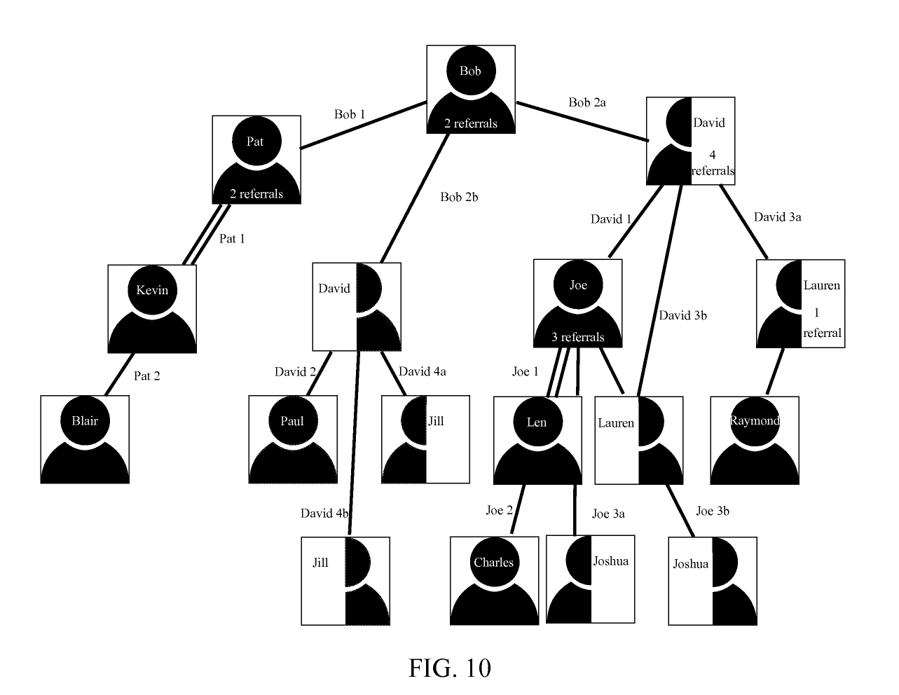

Another example of the process of the present invention is shown in FIG. 10. In FIG. 10, Bob is the primary associate. Bob refers two new associates, first Pat and then David. Pat is placed into Bob's whole spot, and David is placed into Bob's half spot and Pat's half spot. Pat then gets two referrals, Kevin and Blair. Pat's whole spot is unoccupied, so Kevin is placed there. Pat's half spot, however, is occupied by David, so the tree must be searched further downline for the next open spot, which is the whole spot under Kevin.

On the right side of the tree, David refers four new associates: Joe, Paul, Lauren, and Jill. The whole spot of David's first half spot is open, so Joe is placed there. Since David is in two half spots, new associate referrals are placed downline of David alternating between his two half spots—thus, since Joe was placed downline of David's first half, Paul must be placed downline of David's second half. The whole spot of David's second half is open, so Paul is placed there. Lauren, David's third referral, is then placed downline of David's first half. The whole spot of David's first half being occupied, the first half of Lauren is placed into the half spot of David's first half, and the second half of Lauren is placed into the next available half spot downline of David's first half, the half spot of Joe. David's fourth referral, Jill, is placed downline of David's second half, in the half spot of David's second half and Paul's half spot.

Lauren then gets one referral, Raymond, who is placed into Lauren's whole spot. Joe then gets three referrals: Len, Charles, and Joshua. Len is placed into the Joe's whole spot. Since Joe's half spot is already occupied, Charles is placed into Len's whole spot. The next available spot downline of Joe is Len's half spot, and subsequently Lauren's half spot, into which Joshua are placed.

Although the invention has been explained in relation to its preferred embodiment, it is to be understood that many other possible modifications and variations can be made without departing from the spirit and scope of the invention as hereinafter claimed.

What is claimed is:

1. A method of implementing an associate referral compensation system with a 1.5-ary hierarchical rooted tree comprises the steps of:
providing a hierarchal associate tree comprising a plurality of associate spots arranged into a plurality of tiers;
wherein each tier comprises at least one associate spot,
wherein an associate spot is occupied if an associate is assigned to the associate spot,
wherein any arbitrary associate spot from the plurality of associate spots on an arbitrary tier is associated with a whole associate spot and a half associate spot from the plurality of associate spots on a subsequent tier,
wherein the subsequent tier is subordinate to the arbitrary tier in the hierarchical associate tree,
wherein the whole associate spot and the half associate spot of the subsequent tier are downline of the arbitrary associate spot;
and wherein subsequent associate spots associated with the whole associate spot and the half associate spot are downline from the arbitrary associate spot;
providing a primary tier and a plurality of subordinate tiers from the plurality of tiers,
wherein a primary associate is assigned to a primary associate spot in the primary tier, and wherein the plurality of subordinate tiers is sequentially subordinate to the primary tier in the hierarchical associate tree;
(A) identifying a new associate as being associated with an arbitrary associate, wherein the arbitrary associate is assigned to an arbitrary associate spot;
(B) searching the hierarchical associate tree downline of the arbitrary associate spot to find an unoccupied associate spot;
(C) assigning the new associate to the unoccupied associate spot, if the unoccupied associate spot is found, and if the unoccupied associate spot is a whole associate spot;
(D) repeating step (B) to find a second unoccupied half associate spot, if the unoccupied associate spot is found, and if the unoccupied associate spot is a first unoccupied half associate spot; and
(E) assigning a first half of the new associate to the first unoccupied half associate spot and a second half of the new associate to the second unoccupied half associate spot, if the first unoccupied half associate spot and the second unoccupied half associate spot are found.

2. The method of implementing an associate referral compensation system with a 1.5-ary hierarchical rooted tree as claimed in claim 1 comprises the steps of:
identifying a first new associate as being associated with the primary associate; and
assigning the first new associate to the whole associate spot associated with the primary associate spot.

3. The method of implementing an associate referral compensation system with a 1.5-ary hierarchical rooted tree as claimed in claim 2 comprises the steps of:
identifying a second new associate as associated with the primary associate;
assigning a first half of the second new associate to the half associate spot associated with the primary associate spot; and
assigning a second half of the second new associate to the half associate spot associated with the whole associate spot of the primary associate spot.

4. The method of implementing an associate referral compensation system with a 1.5-ary hierarchical rooted tree as claimed in claim 1 comprises the steps of:
providing that each of the plurality of subordinate tiers comprises a first associate spot, a plurality of medial associate spots, and a last associate spot from the plurality of associate spots,
wherein the first associate spot, the medial associate spots, and the last associate spot are arranged sequentially across each of the plurality of subordinate tiers, and
wherein the first associate spot, the medial associate spots, and the last associate spot are downline of the arbitrary associate spot;
sequentially searching an arbitrary tier from the plurality of subordinate tiers from the first associate spot to the last associate spot of the arbitrary tier in order to identify an unoccupied associate spot;
sequentially searching a subsequent tier from the plurality of subordinate tiers from the first associate spot to the last associate spot of the subsequent tier in order to identify the unoccupied associate spot, if the unoccupied associate spot is not identified in the arbitrary tier, wherein the subsequent tier is immediately subordinate to the arbitrary tier in the hierarchical associate tree;
assigning the new associate to the unoccupied associate spot, if the unoccupied associate spot is found, and if the unoccupied associate spot is an unoccupied whole associate spot;
assigning a first half of the new associate to the unoccupied associate spot, if the unoccupied associate spot is found, and if the unoccupied associate spot is a first unoccupied half associate spot;
sequentially searching the arbitrary tier and the subsequent tier from the first associate spot to the last associate spot in order to find a second unoccupied half associate spot;
assigning a second half of the new associate to the second unoccupied half associate spot, if the second unoccupied half associate spot is found; and
continuing to sequentially search further subsequent tiers from the first associate spot to the last associate spot of the further subsequent tiers to find a second unoccupied half associate spot, if the second unoccupied half associate spot is not found in the arbitrary tier and the subsequent tier.

5. The method of implementing an associate referral compensation system with a 1.5-ary hierarchical rooted tree as claimed in claim 4, wherein the first associate spot, the medial associate spots, and the last associate spot are arranged from left to right in a visual depiction of the hierarchical associate tree.

6. The method of implementing an associate referral compensation system with a 1.5-ary hierarchical rooted tree as claimed in claim 1 comprises the steps of:
providing that a first half of a referring associate is assigned to a first associate half spot and a second half of the referring associate is assigned to a second associate half spot;
identifying a plurality of new associate referrals as being associated with the referring associate;
alternatingly searching downline from the first associate half spot and the second associate half spot for unoccupied associate spots; and
alternatingly assigning the plurality of new associate referrals to the unoccupied associate spots downline of the first associate half spot and the second associate half spot of the referring associate, if the unoccupied associate spots are found.

7. The method of implementing an associate referral compensation system with a 1.5-ary hierarchical rooted tree as claimed in claim 1 comprises the steps of:
providing a commission value;
providing that an arbitrary associate is assigned to an arbitrary whole associate spot; and
assigning the commission value to the arbitrary associate and to each associate in associate spots upline of the arbitrary whole associate spot.

8. The method of implementing an associate referral compensation system with a 1.5-ary hierarchical rooted tree as claimed in claim 1 comprises the steps of:
providing a half commission value;
providing that a first arbitrary associate half is assigned to a first arbitrary half associate spot and a second arbitrary associate half is assigned to a second arbitrary second half associate spot; and
assigning the half commission value to the first arbitrary associate half, the second arbitrary associate half, and to each associate assigned to associate spots upline of the first arbitrary associate half and the second arbitrary associate half.
